(19) United States
(12) Patent Application Publication
(10) Pub. No.: US 2015/0042115 A1
(43) Pub. Date: Feb. 12, 2015

(54) Spring Loaded Fifth Wheel Release Puller

(71) Applicant: Jack Hayes, Kenai, AK (US)

(72) Inventor: Jack Hayes, Kenai, AK (US)

(21) Appl. No.: 14/453,539

(22) Filed: Aug. 6, 2014

Related U.S. Application Data
(60) Provisional application No. 61/958,768, filed on Aug. 6, 2013.

(51) Int. Cl. B25J 1/04; B66F 19/00

(52) U.S. Cl. CPC B25J 1/04; B66F 19/00
USPC 294/175

(57) ABSTRACT

The Spring Loaded Fifth Wheel Release Puller of the present invention is designed to minimize the impact forces felt by a user when using the tool to release the locking mechanism from a fifth wheel by pulling on the fifth wheel release handle. The Spring Loaded Fifth Wheel Release Puller minimizes the forces felt by the user by dissipating the amount of reflected energy to the user as a result of delivering a large amount of energy to the tool. This is accomplished by utilizing an energy absorbing device such as a spring between the contact point of the delivered force and the user delivering the force. The Spring Loaded Fifth Wheel Release Puller of the present invention includes a fifth wheel handle puller, a housing, an energy absorbing device, and a grip handle; the energy absorbing device of the present invention being the spring system.

### RELATED APPLICATIONS

This application claims the benefit of priority to U.S. Provisional Application No. 61/958,768, entitled “Spring Loaded Fifth Wheel Release Puller” filed on Aug. 6, 2013, and currently co-pending.

### FIELD OF INVENTION

The present invention is directed to a commercial vehicle tool, and more particularly, but not exclusively, to a fifth wheel release puller.

### BACKGROUND OF INVENTION

Semi-tractor trailer trucks are an essential part of any economy as they provide a means of transporting large quantities of raw materials and finished goods over land. Semi-tractor trailer trucks are used by a multitude of different industries such as the construction, manufacturing, transportation, and warehousing industries. In the United States of America alone, there are over 11 million semi-tractor trailer trucks operating.

Further, approximately 70 percent of all goods are delivered over land are by semi-tractor trailer trucks. Semi-tractor trailer trucks in America are responsible for the majority of freight movement over land and are vital tools.

As an essential and vital tool of the economy, the minimization of time goods are spent in transit increases productivity. Increased productivity in the industry comes from two sources; fewer empty miles and less time waiting between loads. As a result, modern technology has significantly improved the semi-tractor trailer truck to enable the trucks to spend more time on the road transporting goods and not sitting idle. Increases in fuel economy have allowed semi-tractor trailer trucks to stay on the road longer thereby minimizing the time spent idle at refueling stations. Advancements in satellite communications allow drives to take the shortest, quickest, or most efficient routes. With the advancements in technology keeping semi-tractor trailer trucks on the road longer, there still exists a low-tech problem inhibiting the semi-trailer trucks from quickly getting back on the road once stopped.

A common problem preventing semi-tractor trailer trucks from getting back on the road once the goods are delivered is a rusted, stuck, or seized fifth wheel locking mechanism, sometimes referred to as “fifth wheel locking jaws,” preventing a tractor trailer from disengaging with a fifth wheel of the semi-tractor trailer truck. Semi-tractor trailer trucks often travel great distances to pick up and deliver goods with routes up to thousands of miles. As the semi-tractor trailer trucks travel across land they are exposed to a multitude of harsh, punishing natural and unnatural environments. As a result, the fifth wheel and fifth wheel pin are exposed to those harsh and punishing conditions, resulting in the rusted, stuck, or seized fifth wheel locking mechanism which requires additional time and effort to release. Releasing the rusted, stuck, or seized fifth wheel locking mechanism requires a truck driver to physically exert a large force on the release handle of the locking mechanism. Often times, the truck driver has to repeatedly hammer or pull the fifth wheel locking handle and mechanism to create a cyclical force sufficient to loosen the fifth wheel locking mechanism. Consequently, the large amounts of force and the cyclical application of those large forces cause serious muscle, tendon, ligament, and joint strains. Also, because the fifth wheel locking mechanism is located in the center of the tractor trailer, the truck driver must crawl between the trailer and the semi-truck to release the trailer.

In light of the above, it would be advantageous to provide a tool capable of delivering a large force to release the rusted, stuck or seized locking mechanism of a fifth wheel. It would further be advantageous to provide a tool capable of minimizing the impact of delivered forces on the user's body.

### SUMMARY OF THE INVENTION

A Spring Loaded Fifth Wheel Release Puller of the present invention is designed to minimize the impact forces felt by a user when using the tool to release a locking mechanism of a fifth wheel to release the trailer king pin. The Spring Loaded Fifth Wheel Release Puller minimizes the forces felt by the user by absorbing and dissipating the amount of energy reflected to the user as a result of delivering a large amount of energy to the tool. This is accomplished by utilizing an energy absorbing device such as a spring, shock absorber, or dampener between the contact point of the delivered force and the user delivering the force. As the user transfers and delivers the force to the handle of the tool, the tool comes into contact with the fifth wheel locking mechanism release handle which may not absorb all of the forces delivered, thereby reflecting the energy back into the tool and to the user. With the energy absorbing device placed between the user's handle and the point of contact of the tool with the fifth wheel locking mechanism release handle, the energy reflected is absorbed by the energy absorbing device.

In a preferred embodiment of the Spring Loaded Fifth Wheel Release Puller of the present invention, the Spring Loaded Fifth Wheel Release Puller includes a fifth wheel handle puller, a housing coupled to the fifth wheel handle puller and having a shock-absorbing spring, and a grip handle extending from the housing; the energy absorbing device of the present invention in a preferred embodiment, being a spring. The fifth wheel handle puller is an elongated metal rod having a first end and a second end; the first end is formed with a “J” loop and the second end is formed with a retaining plate. The grip handle is a metal rod formed into the shape of a triangle and is affixed to the housing, which is a cylindrical tube having a first enclosed end formed with a center bore and a second enclosed end. The springs placed within the housing and the fifth wheel handle puller is threaded through the springs and the bore of the spring retainer until the retaining plate contacts the springs. The bore is sized to allow the fifth wheel handle puller to traverse in and out of the bore without interference, The housing length is sized similar to the resting length of the springs which results in the springs forming a tight clearance with the housing. This pushes the fifth wheel handle puller against the second end of the housing.

In use, a user grips the grip handle of the present invention and loops the “J” loop of the first end of the fifth wheel handle puller around the fifth wheel locking mechanism fifth wheel handle. The user pulls on the grip handle, thereby transferring the users pulling force to the fifth wheel handle puller which applies the force to the fifth wheel locking mechanism fifth wheel handle in the expectation of releasing the fifth wheel locking jaws. In circumstances where the fifth wheel locking mechanism fifth wheel handle is unable to absorb all of the forces delivered, the force reflected back to the Spring Loaded Fifth Wheel Release Puller is subsequently absorbed by the energy absorbing device, such as the springs. The springs compress in response to the force and absorb and dissipate the energy, thereby minimizing the force reflected to the user. Indeed, when the fifth wheel handle is jammed or corroded, the user can repeatedly pull on the handle imparting significant forces to disengage the fifth wheel, while minimizing any impact or shock felt by the user.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of the Spring Loaded Fifth Wheel Release Puller of the present invention, showing the fifth wheel release puller, the spring retainer, and the grip handle;

FIG. 2 is a front view of the Spring Loaded Fifth Wheel Release Puller;

FIG. 3 is a right side view of the Spring Loaded Fifth Wheel Release Puller;

FIG. 4 is a left side view of the Spring Loaded Fifth Wheel Release Puller showing a cutaway view of the spring retainer; and

FIG. 5 is a right side view of the Spring Loaded Fifth Wheel Release Puller showing a cutaway view of the spring retainer.

### DETAILED DESCRIPTION OF THE INVENTION

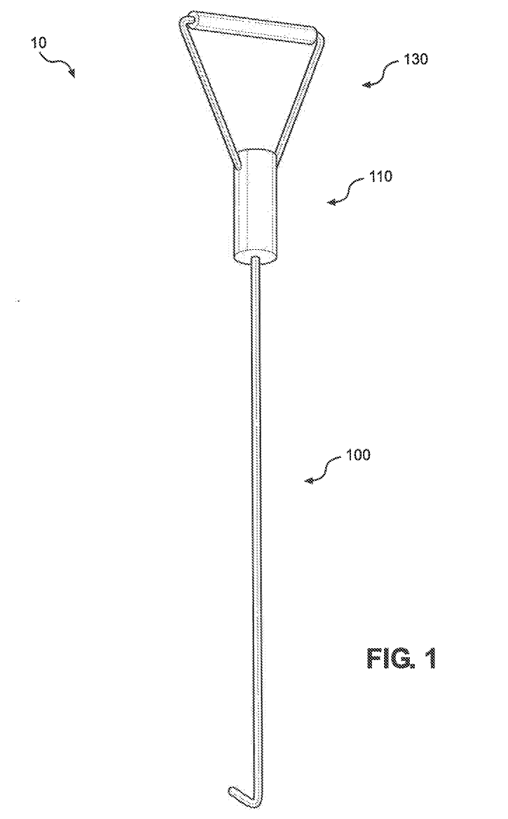

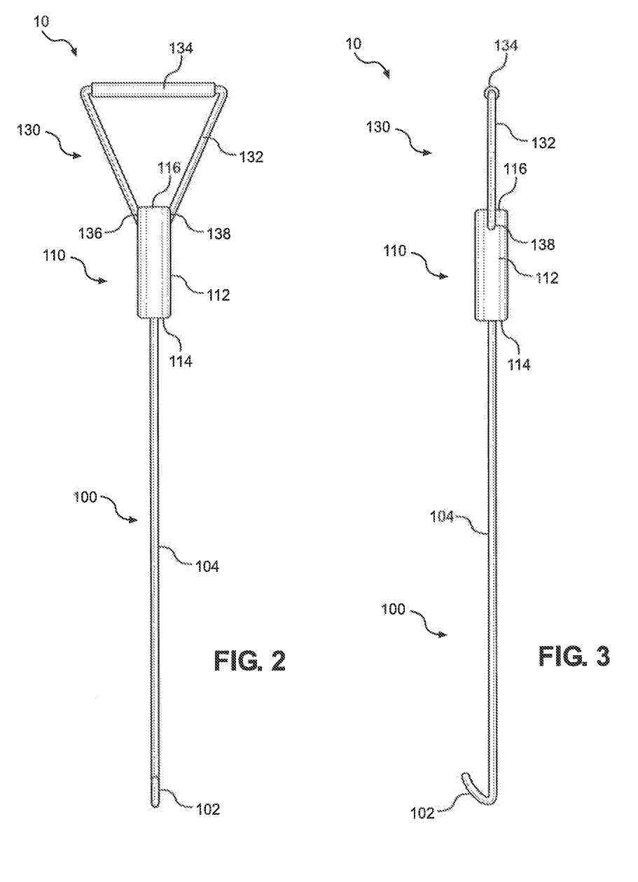

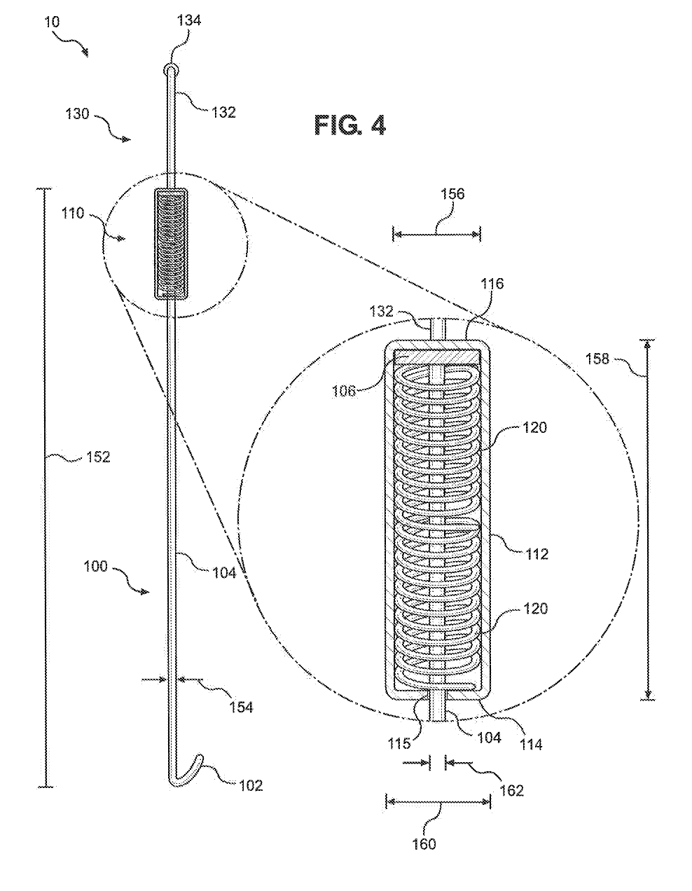

Referring initially to FIG. 1, a perspective view of the Spring Loaded Fifth Wheel Release Puller of the present invention is shown and generally designated 10. Spring Loaded Fifth Wheel Release Puller 10, described in conjunction with FIG. 2 and FIG. 3, includes a fifth wheel handle puller 100, a housing 110, spring system 120 (shown in FIG. 4), and grip handle 130.

Referring now to FIG. 2, the fifth wheel handle puller 100 is an elongated metal rod 104 with a “J” loop, or hook, 102 formed at a first end of the elongated metal rod 104 and a retaining plate 106 (shown in FIG. 4) formed at a second end of the elongated metal rod 104. The elongated metal rod 104 is located at the center of retaining plate 106. The “J” loop 102 is formed as a 45 degree bend at the first end of the elongated metal rod 104. The 45 degree angle of the “J” loop 102 allows the “J” loop 102 to hook onto a handle of a fifth wheel. This allows the “J” loop 102 to securely grip onto the handle as a force is applied to the handle by the “J” loop 102, thereby preventing the Spring Loaded Fifth Wheel Release Puller 10 from dislodging from the handle as it is being pulled. It is contemplated that the “J” loop 102 may be formed with a variety of different shapes such as a 180 degree circular loop or a square without departing from the spirit and scope of the invention.

The housing 110 is a cylindrical tube 112 having an enclosed first end 114 formed with a center bore 115 (shown in FIG. 4) and an enclosed second end 116. As shown in FIG. 4, the retaining plate 106 of the fifth wheel handle puller 100 is housed within the cylindrical tube 112 between the first end 114 and the second end 116. The elongated metal rod 104 extends from the center of the retaining plate 106 through the center bore 115 located at the center of the first end 114 of the cylindrical tube 112, ensuring the elongated metal rod 104 is aligned axially with the center of the housing 110. The axial alignment of the elongated metal rod 104 and the housing 110 allows the elongated metal rod 104 to protrude straight out of the housing 110, thereby minimizing any side forces which may result by the elongated metal rod 104 disposed at an angle. The interior diameter of the cylindrical tube 112 is larger than the diameter of the retaining plate 106 and the diameter of the center bore 115 is larger than the diameter of the elongated metal rod 104 to provide adequate clearance for a running fit between the parts. The running fit between the fifth wheel handle puller 100 and the housing 110 allows the fifth wheel handle puller 100 to traverse in and out of the housing 110 without significant interference while ensuring the fifth wheel handle puller 100 is axially aligned with the housing 110.

Referring back to FIGS. 1-3, the grip handle 130 is a metal rod 132 having a first end 136 and a second end 138 attached to the exterior of the housing 110 and formed into the shape of a triangle. The triangular metal rod 132 is formed with three sides and three vertices. The attachment point of the first end 136 and the second end 138 to the housing 110 form one of the vertices of the triangle where opposite of the attachment points is one of the sides forming the base of the triangle in which the handle cover 134 is attached. It is contemplated that the metal rod 132 may be formed into a variety of different shapes such as a T-shape, a circle, a square, or an L-shape without departing from the spirit and scope of the invention.

The orientation of the triangular metal rod 132 positions the handle cover 134 along the axial center of the housing 110 and the fifth wheel handle puller 100. As a result, the fifth wheel handle puller 100, the housing 110, the spring system 120, and the grip handle 130 are all axially aligned. This allows the triangular metal rod 132 to provide a point where a user can grip and deliver the maximum amount of force against the fifth wheel handle, as the force is concentrated as a force vector having a single component. The force applied on the handle cover 134 of the handle grip 130 is applied and directly transferred to the fifth wheel handle puller 100, allowing the maximum amount of forced to be applied on the handle.

Referring now to FIG. 4, a side view of the Spring Loaded Fifth Wheel Release Puller 10 is shown with a cutaway section of the housing 110 showing the spring system 120 placed within the cylindrical tube 112 of the housing 110 between the retaining plate 106 of the fifth wheel handle puller 100 and the first end 114 of the cylindrical tube 112. The spring system 120, in a preferred embodiment, includes two springs stacked on top of each other in a series orientation. However, it is contemplated that spring system 120 may include a single spring or multiple springs and the orientation of the springs may be in a series setup as shown, or alternatively a co-axial configuration wherein a smaller diameter spring is placed within a larger diameter spring. In the preferred embodiment, the two springs of the spring system 120 have the same spring constants. However, it is further contemplated that each of the springs in the spring system 120 may have different spring constants which may result in a more dynamic spring response when absorbing energy. The use of coil springs for the spring system 120 is not meant to be limiting and it is further contemplated that other types of springs may be used such as torsion springs, volute springs, or various other spring-like devices such as an elastic body having a spring constant. As an alternative to the spring, any energy-absorbing device known in the industry can be used, included but not limited to, viscous dampeners, shock absorbers having hydraulic or pneumatic resistance, or gas filled pistons. The functional benefit of a shock absorbing device within housing 110 is accomplished using any dampening method known in the art.

The spring system 120 is placed over the elongated metal rod 104. The diameter of the springs in the spring system 120 is slightly smaller than the interior diameter of the cylindrical tube 112. The tight clearance between the exterior diameter of the spring system 120 and the interior diameter of the cylindrical tube 112 centers the spring system 120 within the cylindrical tube 112 and prevent the spring system 120 from shifting which may cause uneven force distribution when the spring system 120 is compressed. Alternatively, the spring system 120 may have smaller diameter springs held in place within the housing 110 by physical indents or detents formed within the housing 110.

The resting length of the springs of the spring system 120 is equal to the distance between the retaining plate 106 and the first end 114 of the cylindrical tube 112. The length of the springs in the spring system 120 ensures the spring system 120 presses the retaining plate 106 of the pin puller 100 against the second end 116 of the housing 110, keeping a portion of the elongated metal rod 104 within the housing 110 providing a travel distance for the fifth wheel handle puller 100. Further, the slight friction pressing the retaining plate 106 against the second end 116 of the housing 110 allows the fifth wheel handle puller 100 to be freely rotated to position the “J” loop 102 around the handle of a fifth wheel from multiple positions.

In the preferred embodiment of the Spring Loaded Fifth Wheel Release Puller 10 of the present invention, the fifth wheel handle puller 100, housing 110, springs 120, and grip handle 130 are made from steel. The use of steel is not meant to be limiting and it is contemplated that different materials may be used having similar physical properties and characteristics as steel.

In a preferred embodiment, the elongated metal rod 104 of fifth wheel handle puller 100 is made of steel rod with a diameter 150 of 0.375 inch, and having an overall length 152 of between 28 and 30 inches, with the first end formed with the “J” loop 102 having a length between 1 and 1.5 inches and the second end formed with a retaining plate 106 having a diameter 156 of between 1 and 1.5 inches. The housing 110 has a length 158 of 4.875 inch with an exterior diameter 160 of 1.5 inches. The center bore 115 formed at the first end 114 of the cylindrical tube 112 has a diameter 162 marginally larger than 0.375 inch to provide clearance for the elongated metal rod 104. The grip handle 130 is formed of 0.375 steel rod. The length of the side between the first attachment point 136 and the vertex intersecting the base of the triangle is 7 inches and the length of the side between the second attachment point 138 and the vertex intersecting the base of the triangle is 7 inches with the base having a length of 6.5 inches. In a preferred embodiment, handle cover 134 has an interior diameter of 0.625 inches and an outer diameter of 0.875 inches, and is made of a resilient material, such as foam or rubber, and intended to further absorb shock and prevent the user from being subjected to the impact of the hook 102 forcibly striking the fifth wheel release handle.

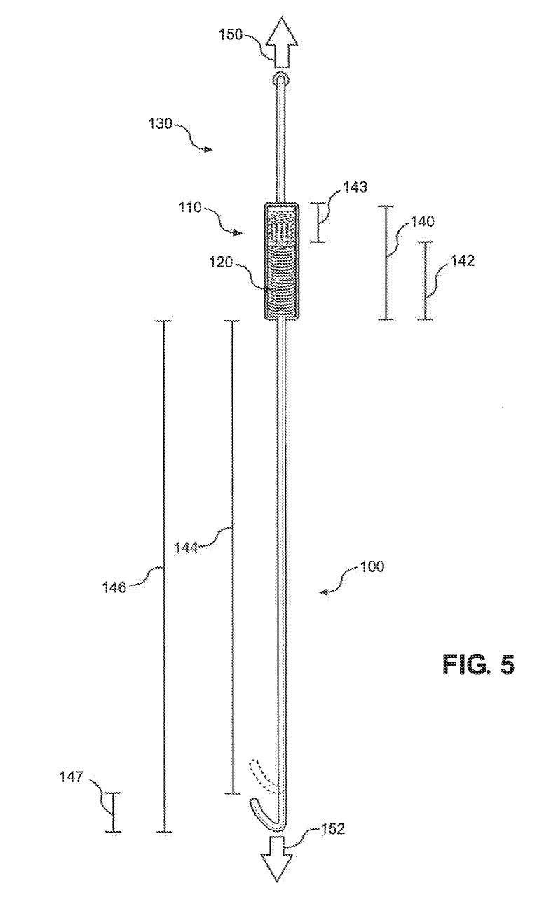

Referring now to FIG. 5, a side view of the Spring Loaded Fifth Wheel Release Puller 10 is shown with a cutaway section of the housing 110 showing the spring system 120 placed within the cylindrical tube 112 of the housing 110 between the retaining plate 106 of the fifth wheel handle puller 100 and the first end 114 of the cylindrical tube 112. In a rest position, designated by the dashed lines shown in FIG. 5 and as shown in FIGS. 1-4 above, the spring system 120 has a rest length 140. The rest length 140 of the spring system 120 presses the fifth wheel handle puller 100 against the housing 110 and keeps a length of the fifth wheel handle puller 100, equal to the resting length 140 of the springs, within the housing 110 as a travel length 147 for the fifth wheel handle puller 100. The fifth wheel handle puller 100 has an exposed resting length 144.

The spring system 120 of the present invention is configured to have a spring constant and a spring stroke. The spring constant of the springs in the spring system 120 dictates the amount of compression the spring system 120 experiences for a force applied. For a higher spring constant, more force is required to compress the spring a unit length whereas for a lower spring constant, less force is required to compress the spring the same unit length. The spring stroke is the length a spring may travel. Due to the mechanical limitations of a spring, the spring stroke of a spring has a maximum length in which it may compress. A spring reaches its maximum spring stroke when all of the individual coils of the spring are in contact with each adjacent coil, thus preventing further compression. In the preferred embodiment, the spring constant and spring stroke of the spring system 120 are balanced to provide the desired amount of compression for a force applied.

As shown in FIG. 5, the Spring Loaded Fifth Wheel Release Puller 10 is subject to a first force 150 and a second force 152. The first force 150 represents the force delivered by a user when the user is using the Spring Loaded Fifth Wheel Release Puller 10 to release the coupling in a fifth wheel. The fifth wheel handle puller 100 is looped around the fifth wheel handle and the user grips the grip handle 130 and pulls back on the grip handle 130 in the direction of the first force 150. The first force 150 is delivered along the axial center of the Spring Loaded Fifth Wheel Release Puller 10 and delivered to the fifth wheel handle puller 100 which is in contact with the fifth wheel handle. In response to the first force 150, the fifth wheel handle puller 100 experiences a second force 152 substantially equal to and opposite to the first force 150.

In instances where the first force 150 is not fully absorbed by the fifth wheel handle puller 100, such as when the fifth wheel jaws are rusted, seized, or frozen, the force is reflected back through the Spring Loaded Fifth Wheel Release Puller 10. The spring system 120, an energy absorbing device, absorbs the reflected energy and converts it into mechanical kinetic energy by compressing the springs of the spring system 120 a compression length 143. The energy absorbed compresses the spring system 120 from resting length 140 to compressed length 142 and temporarily stores the energy when compressed. The stored energy in the spring system 120 is released once the spring system 120 is uncompressed and returns to its original resting length 140. As a result of the spring system 120 compressing, the fifth wheel handle puller 100 extends out of the housing 110 a distance 147. The fifth wheel handle puller 100 extends from the rest length 144 to the extended length 146.

While the Spring Loaded Fifth Wheel Release Puller of the present invention as herein shown and disclosed in detail is fully capable of obtaining the objects and providing the advantages herein before stated, it is to be understood that it is merely illustrative of the preferred embodiments of the invention and that no limitations are intended to the details of construction or design herein shown other than as described in the appended claims.

I claim:

1. A Spring Loaded Fifth Wheel Release Puller comprising:
a housing;
an energy absorbing device housed within said housing;
a fifth wheel handle puller having a first end and a second end, said second end retained within said housing and interfacing with said energy absorbing device and said first end protruding out of said housing; and
a handle grip attached to an exterior of said housing.

2. The Spring Loaded Fifth Wheel Release Puller of claim 1, wherein said housing comprises:
a cylindrical tube having a first end and a second end;
a first cap with a center bore enclosing said first end; and
a second cap enclosing said second end.

3. The Spring Loaded Fifth Wheel Release Puller of claim 2, wherein said fifth wheel handle puller is an elongated metal rod further comprising:
a “J” loop formed on said first end;
a retainer plate attached to said second end; and
wherein said retaining plate is housed within said cylindrical tube of said housing between said first cap and said second cap, and said elongated metal rod protruding through said center bore are axially aligned.

4. The Spring Loaded Fifth Wheel Release Puller of claim 3, wherein said energy absorbing device is a spring system housed within said cylindrical tube between said first cap and said retainer plate, said spring system interfacing with said first cap of said cylindrical tube and said retaining plate of said fifth wheel handle puller.

5. The Spring Loaded Fifth Wheel Release Puller of claim 4, wherein said handle grip is an elongated metal rod having a first end and a second end, wherein said first end and said second end is attached to said housing.

6. The Spring Loaded Fifth Wheel Release Puller of claim 5, wherein said handle grip is formed into a triangular shape having three sides and three vertices, said first end and said second end forming an attachment vertex.

7. The Spring Loaded Fifth Wheel Release Puller of claim 6, wherein said handle grip further comprises a handle cover rotatably attached to a side of said triangle opposite of said attachment vertex.

8. The Spring Loaded Fifth Wheel Release Puller of claim 7, wherein said axial center of said cylindrical tube projects through said attachment vertex and said handle cover.

9. The Spring Loaded Fifth Wheel Release Puller of claim 8, wherein said spring system comprises a first spring with a first spring constant and a second spring having a second spring constant oriented in a series configuration, said first spring constant and said second spring constant are equal.

10. A Spring Loaded Fifth Wheel Release Puller comprising:
a cylindrical tube having an enclosed first end with a center bore and an enclosed second end;
an elongated metal rod having a first end formed with a “J” loop and a second end formed with a retaining plate, wherein said retaining plate is retained within said cylindrical tube and said elongated metal rod protrudes through said center bore;
a spring system retained within said cylindrical tube, said spring system place between said enclosed first end and said retaining plate;
a handle grip runs through said cylindrical tube; and
wherein said cylindrical tube, said elongated metal rod, said spring, and said handle grip are axially aligned.

11. The Spring Loaded Fifth Wheel Release Puller of claim 10, wherein said spring system comprises a first spring with a first spring constant and a second spring having a second spring constant.

12. The Spring Loaded Fifth Wheel Release Puller of claim 11, wherein said first spring and said second spring is oriented in a series configuration.

13. The Spring Loaded Fifth Wheel Release Puller of claim 12, wherein said first spring constant is equal to said second spring constant.

14. The Spring Loaded Fifth Wheel Release Puller of claim 13, wherein said handle grip is an elongated metal rod having a first end and a second end, wherein said first end and said second end is attached to said housing.

15. Spring Loaded Fifth Wheel Release Puller of claim 14, wherein said handle grip is formed into a triangular shape having three sides and three vertices, said first end and said second end forming an attachment vertex.

16. The Spring Loaded Fifth Wheel Release Puller of claim 15, wherein said handle grip further comprises a handle cover rotatably attached to a side of said triangle opposite of said attachment vertex.

17. The Spring Loaded Fifth Wheel Release Puller of claim 16, wherein said axial center of said cylindrical tube projects through said attachment vertex and said handle cover.

18. The Spring Loaded Fifth Wheel Release Puller of claim 17, wherein said “J” loop is formed by bending said first end of said elongated metal rod at 45 degrees.

19. The Spring Loaded Fifth Wheel Release Puller of claim 10, wherein said spring system comprises a spring having a spring constant.
